(19) United States
(12) Patent Application Publication
(10) Pub. No.: US 2015/0207168 A1
(43) Pub. Date: Jul. 23, 2015

(54) FLEXIBLE SECONDARY BATTERY

(71) Applicant: Samsung Electronics Co., Ltd., Suwon-si (KR)

(72) Inventors: Euncheol DO, Seoul (KR); Moonseok KWON, Hwaseong-si (KR); Jaeman CHOI, Hwaseong-si (KR); Chilhee CHUNG, Seoul (KR); Yeonil LEE, Seoul (KR)

(21) Appl. No.: 14/600,502

(22) Filed: Jan. 20, 2015

(30) Foreign Application Priority Data
Jan. 20, 2014 (KR) 10-2014-0006746

(51) Int. Cl. H01M 10/04; H01M 4/62

(52) U.S. Cl. CPC H01M 10/04; H01M 4/62; H01M 2220/30

(57) ABSTRACT

A flexible secondary battery includes an electrode stack structure including a first electrode layer, a second electrode layer opposite to the first electrode layer and a separator formed between the first electrode layer and the second electrode layer, and a fixing unit disposed in the electrode stack structure at an area excluding opposing end portions of the electrode stack structure, where the fixing unit fixes portions of the first electrode layer, the second electrode layer and the separator, which correspond thereto, to each other. The fixing unit may be disposed at a center portion or an area adjacent to the center portion of the electrode stack structure.

### CROSS-REFERENCE TO RELATED APPLICATION

This application claims priority to Korean Patent Application No. 10-2014-0006746, filed on Jan. 20, 2014, and all the benefits accruing therefrom under 35 U.S.C. §119, the content of which is incorporated herein in its entirety by reference.

### BACKGROUND

1. Field

Disclosed is a flexible secondary battery.

2. Description of the Related Art

Due to technological improvement in consumer electronics, a market of electronic apparatuses, which includes not only cellular phones, game consoles, portable multimedia players (“PMP”), and mpeg audio layer-3 (“MP3”) players, but also various mobile electronic apparatuses such as smart phones, smart pads, electronic book terminals, flexible tablet computers, and body-attachable mobile medical apparatuses, for example, has significantly grown.

As the market related to mobile electronic apparatuses grows, a demand for batteries for mobile electronic apparatuses increases. That is, a demand for batteries having durability against movement, storage and impact has increased.

### SUMMARY

A conventional battery may include a layered structure including a positive electrode, a separator, and a negative electrode. When such a battery is bent, a phenomenon of performance decrease may occur due to slippage between two electrodes. For example, friction due to electrode slippage may cause damage to inner layers and stress may be concentrated on interfaces between inner layers, thereby causing a phenomenon of layer separation. When the radius of curvature of inner layers is small, the magnitude of slippage of each electrode may increase. When such a battery is bent, if the inner space is not sufficient or sufficient slippage does not occur due to friction, a hollow space may occur at each electrode such that the performance and life of a battery may be affected.

Provided are embodiments of a method and an apparatus for a flexible secondary battery configured to deform in various ways, such as bending and bowing and to maintain stability in deformed state. Additional aspects will be set forth in part in the description which follows and, in part, will be apparent from the description.

According to an embodiment of the invention, a flexible secondary battery includes: an electrode stack structure including a first electrode layer, a second electrode layer opposite to the first electrode, and a separator between the first electrode layer and the second electrode layer; a fixing unit disposed in the electrode stack structure at an area excluding opposing end portions of the electrode stack structure, where the fixing unit fixes portions of the first electrode layer, the second electrode layer and the separator, which correspond thereto, to each other.

In an embodiment, the fixing unit may be disposed at a center portion of the electrode stack structure or at an area adjacent to the center portion of the electrode stack structure.

In an embodiment, the area adjacent to the center portion of the electrode stack structure may be closer to the center portion of the electrode stack structure than to one of the opposing end portions of the electrode stack structure.

In an embodiment, the electrode stack structure may include an additional fixing unit.

In an embodiment, the fixing unit may include adhesive or a tape with adhesive applied.

In an embodiment, the fixing unit may be defined by a portion of a spot-welded structure or a riveting structure.

In an embodiment, the first electrode layer may include a first metal collector and a first active material layer disposed on a surface of the first metal collector, and the second electrode layer may include a second metal collector and a second active material layer disposed on a surface of the second metal collector.

In an embodiment, the flexible secondary battery may further include connecting tabs defined by a portion of the first metal collector or the second metal collector.

In an embodiment, the flexible secondary battery may further include a protecting layer disposed on a surface of the electrode stack structure.

In an embodiment, bending rigidity of the protecting layer may be larger than an average bending rigidity of individual layers inside the electrode stack structure.

In an embodiment, the protecting layer may include a polymer film, a film including laminated polymer layer, a metal foil or a composite film including carbon.

In an embodiment, the electrode stack structure may include: a first electrode stack structure and a second electrode stack structure, where each of the first and second electrode stack structures includes the first and second electrode layers, the fixing unit is disposed in the first electrode stack structure and the second electrode stack structure, and the fixing unit connects the first electrode stack structure and the second electrode stack structure to each other.

In an embodiment, the first and second electrode layers of the first electrode stack structure and the first and second electrode layers of the second electrode stack structure may be connected each other in series or in parallel.

### BRIEF DESCRIPTION OF THE DRAWINGS

These and/or other aspects will become apparent and more readily appreciated from the following description of the embodiments, taken in conjunction with the accompanying drawings, in which:

FIGS. 1A and 1B are side views of an embodiment of a flexible secondary battery according to the invention;

FIG. 2 is a cross-sectional view of an alternative embodiment of a flexible secondary battery according to the invention;

FIGS. 3A through 3C are perspective views illustrating embodiments of a flexible secondary battery including a connecting tab, according to the invention;

FIGS. 4A through 4C are schematic diagrams illustrating embodiments of flexible secondary batteries according to the invention;

FIGS. 5A through 5C are schematic diagrams illustrating structures of embodiments of a flexible secondary battery further including a protection layer, according to the invention; and

FIG. 6 is a graph illustrating comparison results of capacities before and after bending of embodiments of a flexible secondary battery and conventional secondary battery.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims.

Hereinafter, embodiments of a flexible secondary battery will be described in detail in reference to accompanying drawings. Thickness of layers or areas illustrated in diagrams or views may be exaggerated for clarity of specification. Throughout detail explanation, like reference numerals refer to like elements. On the other hand, it should be understood that the exemplary embodiments described therein should be considered in a descriptive sense only and not for purposes of limitation. Descriptions of features or aspects within each embodiment should typically be considered as available for other similar features or aspects in other embodiments.

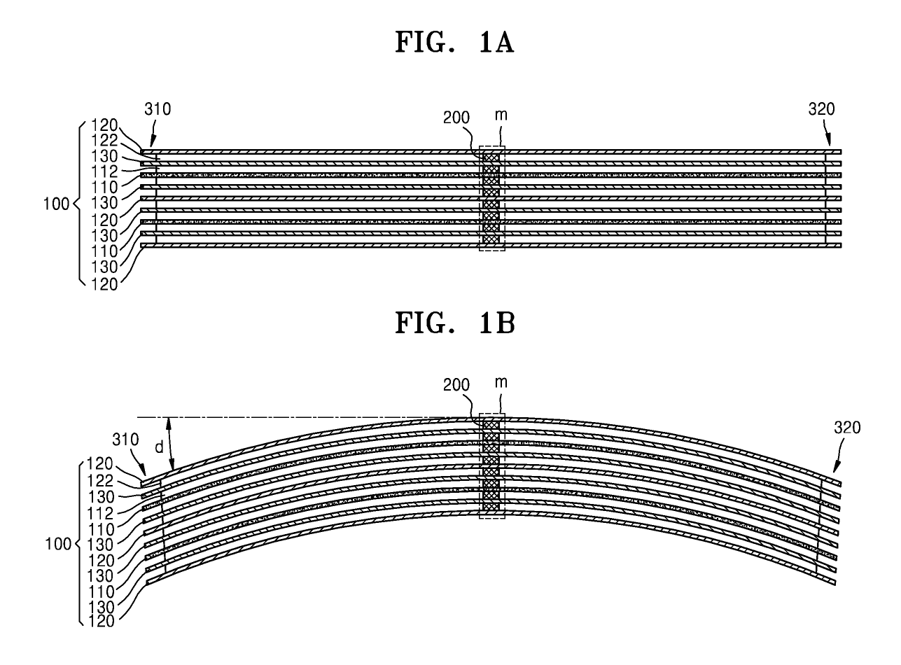

FIGS. 1A and 1B are side views of an embodiment of a flexible secondary battery according to the invention.

Referring to FIGS. 1A and 1B, an embodiment of the flexible secondary battery according to the invention may include an electrode stack structure 100. The electrode stack structure 100 may include a first electrode layer 110, 112, a second electrode layer 120, 122, and a separator 130 between the first electrode layer 110, 112 and the second electrode layer 120, 122. The first electrode layer 110, 112 and the second electrode layer 120, 122 may be alternately disposed (e.g., stacked) one on another and the separator 130 may be disposed between adjacent first and second electrode layers. In such an embodiment, the first electrode layer 110, 112, the separator 130 is disposed on the first electrode layer 110, 112 and the second electrode layer 120, 122 disposed on the separator 130 may define an electrode layer unit structure. A plurality of electrode layer unit structures with a separator between adjacent electrode layer unit structures may define the electrode stack structure 100.

A fixing unit 200, which fixes the electrode stack structure 100 (e.g., fixes corresponding portions thereof to each other), may be disposed in a predetermined space defined in the electrode stack structure 100. The fixing unit 200 may be a fixing structure define din the electrode stack structure 100. The fixing unit 200 may be disposed at a center portion m or an area adjacent or close to the center portion m of the electrode stack structure 100. Herein, the center portion m may be defined as a portion extending in a thickness direction (e.g., a stacking direction of the first electrode layer 110, 112 and the second electrode layer 120, 122 in the electrode stack structure 100) and in a center position with respect to a longitudinal (or major) axis of the electrode stack structure 100. The area adjacent to the center portion m of the electrode stack structure 100 means an area closer to the center portion m than to end portions 310 and 320 at both opposing sides (e.g., left and right side of the electrode stack structure 100 shown in FIGS. 1A and 1B). However, the position of the fixing unit 200 is not limited thereto. In such an embodiment, the fixing unit 200 may be disposed at areas excluding the end portions 310 and 320 at both sides of the electrode stack structure 100

In an embodiment, as illustrated in FIG. 1B, the electrode stack structure 100 may bend due to an outside factor such as pressure. When the outside factor such as pressure is applied to the electrode stack structure 100, the electrode stack structure 100 may be deformed, and the end portions 310 and 320 at both sides, where the fixing unit 200 is not provided, may deform by a distance d due to a bending by the outside factor. When the electrode stack structure 100 is deformed, a slippage may occur between inner layers on both sides of the fixing unit 200 of the electrode stack structure 100, that is, between the first electrode layer 110, 112, the second electrode layer 120, 122, and the separator 130. In an embodiment, when the flexible secondary battery is deformed (e.g., bent) due to the outside factor such as pressure, the flexible secondary battery decreases the degree of slippage and deformation between inner layers of the electrode stack structure 100, and enhance structural stability, by the fixing unit 200 disposed at the center portion m or an area adjacent to the center portion m of the electrode stack structure 100. In such an embodiment, if the fixing unit 200 is disposed at one of the end portions 310 and 320 of the electrode stack structure 100, for example, at the end of a first end portion 310, the deformation at the end on the opposite side, for example, the end of a second end portion 320, may be greater than the distance d, and the amount of slippage between inner layers may increase. In an embodiment, where the fixing unit 200 is disposed at the center portion m or an area adjacent to the center portion m of the electrode stack structure 100, the first electrode layer 110, 112 and the second electrode layer 120, 122 may maintain stable alignment for a reversible electrochemical reaction. In such an embodiment, when the electrode stack structure 100 is repetitively bent, a relative location of each individual layer that defines the electrode stack structure 100 is maintained such that an electrochemical reaction such as charging and discharging is allowed to occur effectively even after repetitive bending.

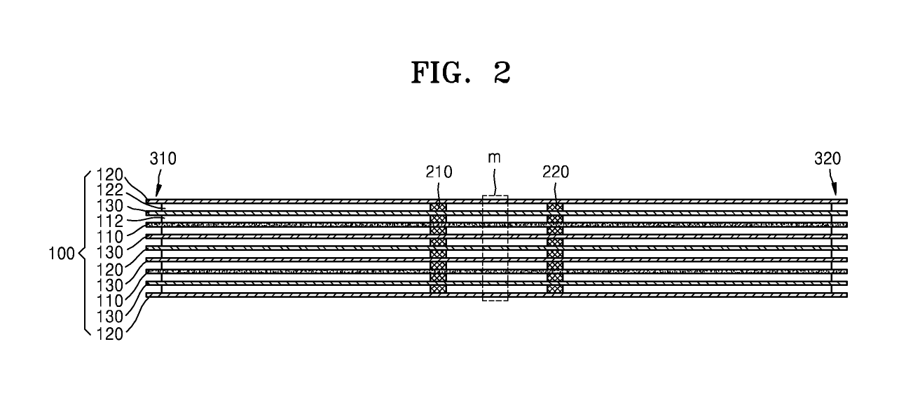

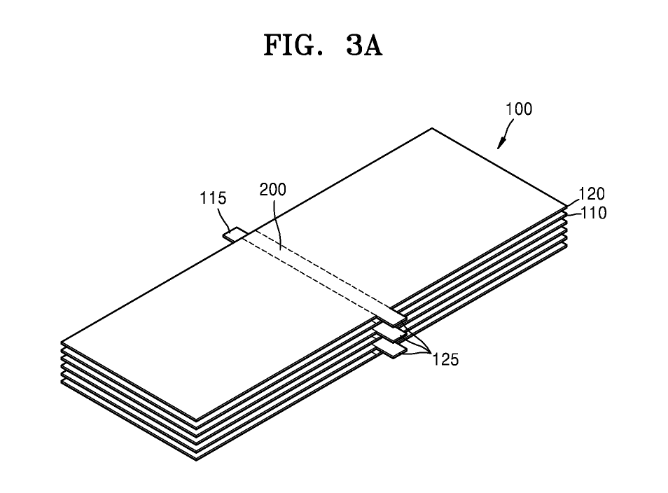

In an embodiment, the flexible secondary battery may include one or more fixing units disposed in the electrode stack structure 100. In one embodiment, for example, a single fixing unit 200 may be disposed at the center portion m of the electrode stack structure 100, as shown in FIGS. 1A and 1B, but not being limited thereto. In an alternative embodiment, as illustrated in FIG. 2, a plurality of fixing units, for example, a first fixing unit 210 and a second fixing unit 220, may be disposed in the electrode stack structure 100 of the flexible secondary battery. In such an embodiment, where the first and second fixing units 210 and 220 are disposed in the electrode stack structure 100, the fixing units (e.g., the first and second fixing units 210 and 220) may be disposed symmetric to each other with respect to a center portion m of the electrode stack structure 100. In such an embodiment, the fixing units (e.g., the first and second fixing units 210 and 220) may have a same width as each other. In an embodiment, the electrode stack structure 100 of the flexible secondary battery may include one or more fixing units disposed at the center portion m or an area adjacent to the center portion m of the electrode stack structure 100.

Hereinafter, layers which define the electrode stack structure 100 of an embodiment of the flexible secondary battery, according to the invention, will now be described in detail.

In an embodiment, the first electrode layer 110, 112 may be either a cathode film or an anode film. In an embodiment, the first electrode layer 110, 112 is a cathode film, and the second electrode layer 120, 122 may be an anode film. In an alternative embodiment, the first electrode layer 110, 112 is an anode film, and the second electrode layer 120, 122 may be a cathode film. In such an embodiment, the first electrode layer 110, 112 may include a first active material layer 112 disposed on a surface of a first metal collector 110. The second electrode layer 120, 122 may include a second active material layer 122 disposed on a surface of a second metal collector 120. In an embodiment, where the first electrode layer 110, 112 is a cathode film, a metal collector 110 of the first electrode layer (also referred to as “first metal collector”) may be a cathode collector, and an active material layer 112 of the first electrode layer (also referred to as “first active material layer”) may be a cathode active material layer. In an embodiment, where the second electrode layer 120, 122 is an anode film, a metal collector 120 of the second electrode layer (also referred to as “second metal collector”) is an anode collector, and an active material layer 122 of the second electrode layer (also referred to as “second active material layer”) may be an anode active material layer. The first active material layer 112 may be disposed on one or both of opposing surfaces of the first electrode layer 110, 112, and the second active material layer 122 may be formed on one or both of opposing surfaces of the second metal collector 120. A length of the second electrode layer 120, 122, e.g., the length thereof in the direction of the longitudinal axis (also referred to as, “longitudinal direction”) of the electrode stack structure 100, may be greater than a length of the first electrode layer 110, 112; however, the invention is not limited thereto.

The cathode collector may be metal material including aluminum, stainless steel, titanium, copper, silver, or a combination thereof. The cathode active material layer may include a cathode active material, a binder and a conductive agent, for example.

The cathode active material layer may include or be formed with a material which may reversibly occlude and release lithium ions. In one embodiment, for example, the cathode active material may include at least one selected from lithium transition oxides such as LiCoO₂, LiNiO₂, LiNiCoO₂, LiNiCoAlO₂, LiNiCoMnO₂, LiMnO₂ and LiFePO₄, and NiS, Cu₂S, sulfur (S), FeO, and VO. The binder may include at least one selected from a polyvinylidene fluoride (“PDVF”) binder such as PDVF, vinyliden fluoride (“VDF”)/hexa-fluoropropylen co-polymer, VDF/tetra-fluoroethylene co-polymer, etc., a carboxymethyl cellulose binder such as sodium-carboxymethyl cellulose, lithium-carboxymethyl cellulose, etc., and a acrylate binder such as polyacrylic acid, lithium-polyacrylic acid, acryl, polyacrylonitrile, polymethylmethacrylate, polybutylacrylate, etc., rubber binders such as polyamideimide, polytetrafluoroethylene, polyethylene oxide, polypyrrole, lithium-nafion and styrene-butadiene.

The conductive agent may include at least one selected from a carbon binder such as carbon black, carbon fiber and graphite, a conductive fiber such as a metal fiber, a metal powder such as carbon fluoride powder, aluminum powder and nickel powder, a conductive whisker such as zinc oxide and potassium titanate, a conductive metal oxide such as titanium oxide, and a conductive polymer such as a polyphenylene derivative, etc.

The anode collector may include at least one metal selected from copper, stainless steel, nickel, aluminum, and titanium. The anode active material layer may include an anode active material, the binder, and the conductive agent, for example.

The anode active material layer may include or be formed with a material which is capable of alloying with lithium or reversible occlusion and releasing of lithium. In one embodiment, for example, the anode active material may include at least one selected from metal, carbon material, metal oxide, and lithium metal nitride. In such an embodiment, the metal may include at least one selected from lithium, silicon, magnesium, calcium, aluminum, germanium, tin, lead, arsenic, antimony, bismuth, silver, gold, zinc, cadmium, mercury, copper, iron, nickel, cobalt, and indium. In such an embodiment, the carbon material may include at least one selected from graphite, graphite carbon fiber, coke, mesocarbon microbeads (“MCMB”), polyacene, pitch carbon fiber, and hard carbon. In such an embodiment, the metal oxide may include at least one selected from lithium titanium oxide, titanium oxide, molybdenum oxide, niobium oxide, iron oxide, tungsten oxide, tin oxide, tin-based amorphous composite oxide (“TCO”), silicon monoxide, cobalt oxide, and nickel oxide.

The binder and the conductive agent of the anode active material layer may be substantially the same as the binder and the conductive agent of the cathode active material layer, respectively.

The cathode film or the anode film may be provided, e.g., formed, by coating the active material layer on the metal collector using various methods, and the coating method of the electrode active material layer is not limited to a specific coating method.

In an alternative embodiment, the active material layer may disposed be on either one or both opposing surfaces of the first metal collector 110 and the second metal collector 120. In such an embodiment, the active material layer on either one or both opposing surfaces of the first metal collector 110 and the second metal collector 120 is substantially the same as the active material layer described above, and any repetitive detailed description thereof will be omitted.

In an embodiment, the separator 130 may include a porous polymer membrane such as polyethylene, or a polypropylene membrane. In an embodiment, the separator 130 may be in the form of fabric or felt including polymer fiber. In an embodiment, the separator 130 may include ceramic particles and may be formed with polymer solid electrolyte. The separator 130 may be formed as an independent film and may be fabricated by forming a nonconductive porous layer on the first electrode layer 110, 112 or the second electrode layer 120, 122. In an embodiment, the separator 130 is formed to electrically separate the first electrode layer 110, 112 and the second electrode layer 120, 122 and may have a shape substantially similar to or same as that of the first electrode layer 110, 112 or the second electrode layer 120, 122. In an alternative embodiment, the shape of the separator 130 may be different from (e.g., not be identical to) the first electrode layer 110, 112 or the second electrode layer 120, 122.

In an embodiment, the fixing unit 200, 210 or 220 may include a material which has low or no reactivity with a material of each inner layer of the electrode stack structure 100. In one embodiment, for example, the fixing unit 200, 210 or 220 may include a polymer film, a film including laminated polymer, a composite material, insulating adhesive or a tape coated with insulating adhesive. The fixing unit 200, 210 or 220 may be formed in various methods. In one embodiment, for example, the fixing unit 200, 210 or 220 may be formed by fixing and adhering either a polymer film or tape in such a way that either a polymer film or tape covers the center portion m or an area adjacent to the center portion m of the electrode stack structure 100. Also, the fixing unit 200, 210 or 220 may be formed by applying insulating adhesive to the center portion m or an area adjacent to the center portion m of one or both sides of each layer that define the electrode stack structure 100. In one embodiment, for example, the fixing unit 200, 210 or 220 may be formed by individually applying adhesive in advance to each of the first metal collector 110, the second metal collector 120 and the separator 130, and aligning and fixing the layers of the electrode stack structure 100. In an alternative embodiment, the fixing unit 200, 210 or 220 may be formed by forming a penetration slot at the center portion m or an area adjacent to the center portion m of the electrode stack structure 100 and inserting the fixing unit 200, 201 or 220. In such an embodiment, the fixing unit 200, 201 or 220 may be, for example, a rivet. The first and second active material layers 112 and 122 may not be formed at predetermined areas of the first metal collector 110, the second metal collector 120 and the separator 130, where the fixing unit 200, 210 or 220 to be disposed. The fixing unit 200, 210 or 220 may have a width larger than about 2 millimeters (mm). A ratio of the total length of the electrode stack structure 100 with respect to the width of the fixing unit 200, 210 or 220 may be less than about 20. Herein, a width of the fixing unit 200, 210 or 220 may be defined as a length thereof in the longitudinal direction of the electrode stack structure 100, and the total length of the electrode stack structure 100 may be defined as a length in the longitudinal direction thereof.

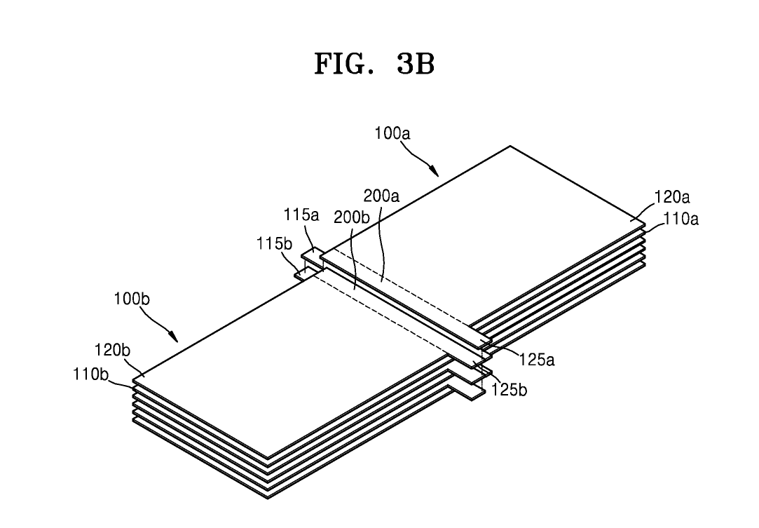

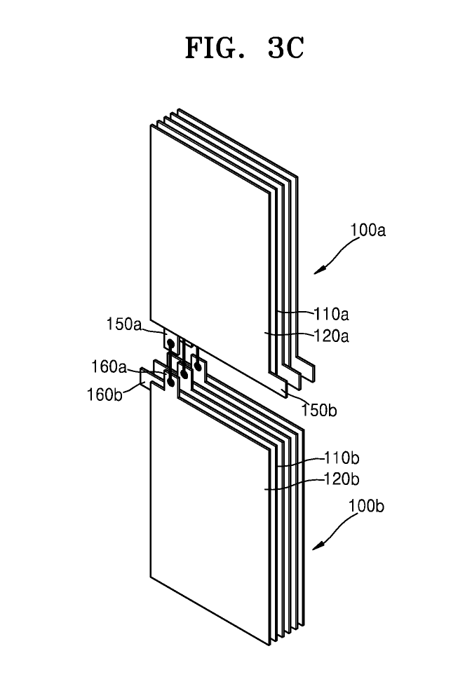

FIGS. 3A through 3C are perspective views of embodiments of a flexible secondary battery including a connecting tab, according to embodiments of the invention.

Referring to FIG. 3A, the electrode stack structure 100 of an embodiment of the flexible secondary battery according to the invention may further include connecting tabs 115 and 125 which extend from the first metal collector 110 and the second metal collector 120 of the electrode stack structure 100. In an embodiment, the connecting tabs 115 and 125 may be defined by extending portions of the first metal collector 110 and the second metal collector 120 of the electrode stack structure 100. The connecting tabs 115 and 125 may be connected to an external lead tab. In such an embodiment, a metal active material layer may be disposed on the surface of the first metal collector 110 and the second metal collector 120 as described above, and any repetitive detailed description thereof will be omitted. The connecting tabs 115 and 125 may be disposed at the center portion m or an area adjacent to the center portion of the electrode stack structure 100. In an embodiment, the connecting tabs 115 and 125 may be connected to portions of the first metal collector 110 and the second metal collector 120 of the electrode stack structure 100, which is corresponding to the fixing unit 200 (e.g., a portion overlapping the fixing unit 200 when viewed from a top view). In one embodiment, for example, the width of the fixing unit 200 may be substantially the same as the width of the connecting tabs 115 and 125. Herein, the width is of the fixing unit 200 and the connecting tabs 115 and 125 may be defined as a length thereof in a direction perpendicular to an extending direction thereof. If the connecting tabs 115 and 125 are provided at an end portion, not at the area where the fixing unit 200 of the electrode stack structure 100, repetitive bending of the electrode stack structure 100 of the flexible secondary battery may cause an increase in the amount of relative location variation. In an embodiment, the connecting tabs 115 and 125 are provided at the area where the fixing unit 200 of the electrode stack structure 100 such that folding or breaking of the connecting tabs 115 and 125 that may occur due to repetitive bending is effectively prevented, and the battery performance may be improved.

Referring to FIG. 3B, an alternative embodiment of the flexible secondary battery according to the invention may include a plurality of electrode stack structures, e.g., a first electrode stack structure 100a and a second electrode stack structure 100b. In such an embodiment, an end portion of the first electrode tack structure 100a and an end portion of the second electrode stack structure 100b may connected to with each, and the flexible secondary battery may further include fixing units 200a and 200b, which are respectively disposed in the first electrode tack structure 100a and the second electrode stack structure 100b, e.g., disposed at the center portion m or an area adjacent to the center portion of an electrode stack structure defined by the first electrode tack structure 100a and the second electrode stack structure 100b or in areas adjacent to the end portions of the first electrode tack structure 100a and the second electrode stack structure 100b. In such an embodiment, connecting tabs 115a and 125a may be disposed at metal collectors 110a and 120a of the first layer structure 100a, respectively. In such an embodiment, connecting tabs 115b and 125b may be disposed at metal collectors 110b and 120b of the second electrode stack structure 100b, respectively. In such an embodiment, when the fixing unit 200a of the first electrode stack structure 100a and the fixing unit 200b of the second electrode stack structure 100b are connected and fixed to each other, the first electrode stack structure 100a and the second electrode stack structure 100b define a structure similar to the electrode stack structure 100 illustrated in FIG. 3A, and the electrode stack structure defined by the electrode stack structures 100a and 100b connected to each other by the fixing units 200a and 200b disposed at the center portion thereof.

Referring to FIG. 3C, an embodiment of the flexible secondary battery according to the invention may include a plurality of electrode stack structures, e.g., the first electrode stack structure 100a and the second electrode stack structure 100b, and fixing units disposed at each of counter areas of the first electrode stack structure 100a and the second electrode stack structure 100b. Connecting tabs 150a and 150b may be disposed at metal collectors 110a and 120a of the first electrode stack structure 100a, respectively. Connecting tabs 160a and 160b may be disposed at metal collectors 110b and 120b of the second electrode stack structure 100b, respectively. In such an embodiment, the connecting tab 150a of the first electrode stack structure 100a and the connecting tab 160a of the second electrode stack structure 100b may be connected to each other. Also, the connecting tab 150b of the first electrode stack structure 100a and the connecting tab 160a of the second electrode stack structure 100b, which have tabs with different polarities, may be used as connecting tabs connected to external lead tabs. In an embodiment as shown in FIG. 3A, the first electrode stack structure 100a and the second electrode stack structure 100b may be connected in series. In an alternative embodiment, as shown in FIG. 3B, the first electrode stack structure 100a and the second electrode stack structure 100b are connected in parallel. In such an embodiment, electrode stack structures may be selectively connected either in series or parallel electrode stack structure.

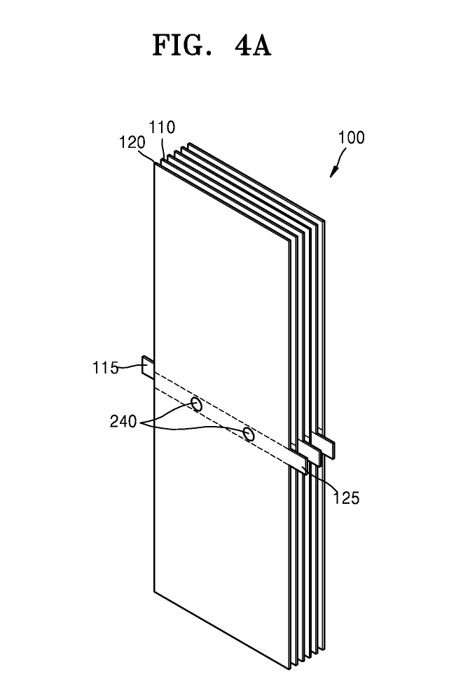

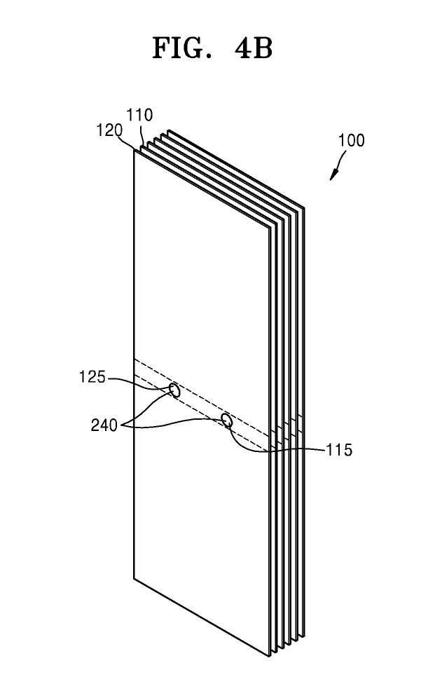

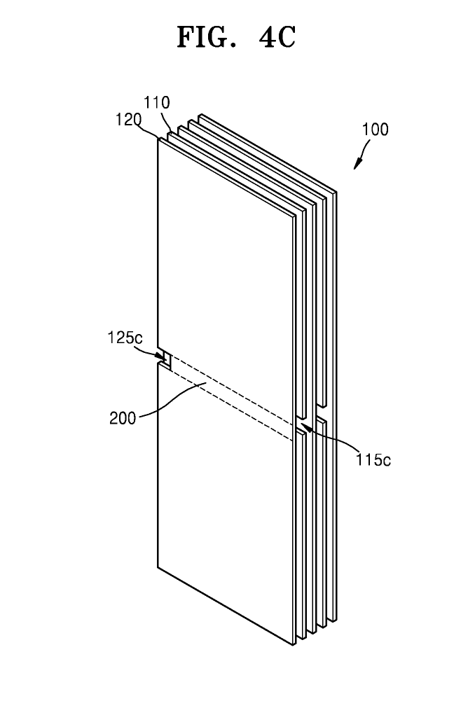

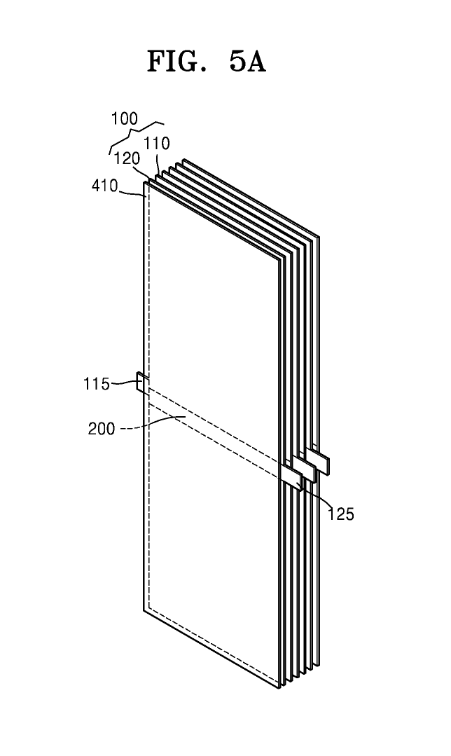

FIGS. 4A through 4C are schematic diagrams illustrating various embodiments of the flexible secondary battery according to the invention.

Referring to FIG. 4A, an embodiment of the flexible secondary battery may include the electrode stack structure 100, and the electrode stack structure 100 may include the first metal collector 110 and the second metal collector 120. In such an embodiment, the first metal collector 110 and the second metal collector 120 may include connecting tabs 115 and 125 which respectively extend or protrude from the first metal collector 110 and the second metal collector 120. In such an embodiment, a metal active material layer may be disposed on surfaces of the first metal collector 110 and the second metal collector 120. Such metal active material layer may be substantially the same as the active material layer described above, and any repetitive detailed description thereof will be omitted.

A fixing unit 240 may be disposed at the center portion or an area adjacent to the center portion of the electrode stack structure 100. The fixing unit 240 may include a riveting structure which penetrates through the first metal collector 110 and the second metal collector 120 of the electrode stack structure 100 or a spot-welded portion provided by spot welding.

Referring to FIG. 4B, another embodiment of the flexible secondary battery may include the electrode stack structure 100. The electrode stack structure 100 may include the first metal collector 110 and the second metal collector 120. The fixing unit 240 may be disposed at the center portion or an area adjacent to the center portion of the electrode stack structure 100. The fixing unit 240 may include a riveting structure which penetrates through the first metal collector 110 and the second metal collector 120 of the electrode stack structure 100 or a spot-welded portion provided by spot welding. In such an embodiment, as shown in FIG. 4B, connecting tabs 115 and 125 are defined by portions of the first metal collector 110 and the second metal collector 120 connected to the fixing unit 240, e.g., center portions of the first metal collector 110 and the second metal collector 120 which are not protruded to the outside of the metal collectors 110 and 120.

Referring to FIG. 4C, another embodiment of the flexible secondary battery may include the electrode stack structure 100, and the electrode stack structure 100 may include the first metal collector 110 and the second metal collector 120. A fixing unit 200 may be disposed at the center portion or an area adjacent to the center portion of the electrode stack structure 100. In such an embodiment, recesses 115c and 125c, which are inwardly cut, may be defined at the center portion or an area adjacent to the center portion of the first metal collector 110 and the second metal collector 120. Such recesses 115c and 125c may be alternately defined on the first metal collector 110 and the second metal collector 120 of the electrode stack structure 100. Such recesses 115c and 125c may be connected to external lead tabs and may function as connecting tabs.

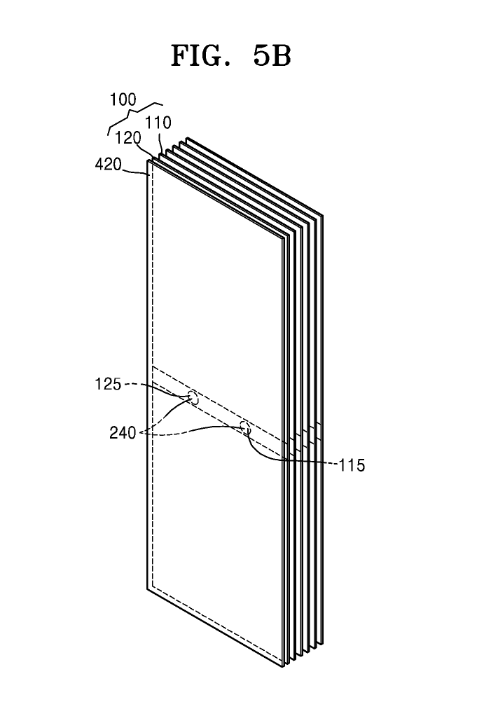

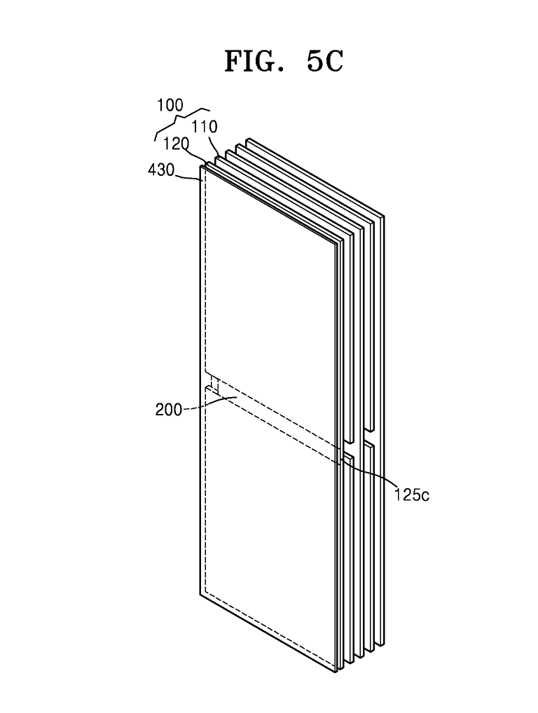

FIGS. 5A through 5C are schematic diagrams illustrating embodiments of a flexible secondary battery further including a protecting layer, according to the invention.

Referring to FIGS. 5A through 5C, an embodiment of a flexible secondary battery according to the invention may include the electrode stack structure 100, and the electrode stack structure 100 may include the first metal collector 110 and the second metal collector 120. Fixing units 200 and 240 may be disposed at the center portion or an area adjacent to the center portion of the electrode stack structure 100. In such an embodiment, the first metal collector 110 and the second metal collector 120 may include portions extending or protruding therefrom and which define connecting tabs 115, 125, and 125c to be connected to external lead tabs. In such an embodiment, the flexible secondary battery may further include a protecting layer 410 (may be referred to as “protection layer”), 420 or 430 disposed on a surface (e.g., an outer surface) of the electrode stack structure 100. In another embodiment, as shown in FIG. 5B, connecting tabs 115 and 125 may defined by portions of the metal collectors 110 and 120 connected to the fixing unit 240, e.g., a center portion of the metal collectors 110 and 120 which are not protruded from the metal collectors 110 and 120.

The protecting layers 410, 420, and 430 may include a material having flexibility and stiffness to control or limit the deformation or bending of the layers of the electrode stack structure 100. Bending stiffness of the protecting layers 410, 420, and 430 may be larger than the average bending stiffness of individual layers of the electrode stack structure 100, and, for example, may have a value greater than about 1.5 times an average value of bending stiffness of individual layers. The protecting layers 410, 420 and 430 may have a thickness in a range of 15 micrometers (μm) to 1 mm. In an embodiment, the protecting layers 410, 420, and 430 may include a polymer film. In such an embodiment, a film may include a laminated polymer film layer, metal foil, or a composite film including carbon. The protecting layers 410, 420, and 430 may protect layers therebelow, e.g., layers of the electrode stack structure 100, from physical impact or external chemical influences of the electrode stack structure 100. When the electrode stack structure 100 is deformed due to bending or bowing, the inside of the electrode stack structure 100 is subjected to compression, and thus, individual layers may generate wrinkles to relieve such compression. When wrinkles are generated in individual layers of the electrode stack structure 100, gaps between individual layers widens and an alignment location may be irreversibly changed or a folding risk may increase. In an embodiment, the protecting layers 410, 420, and 430 having constant flexibility and stiffness and provided outside of the electrode stack structure 100 may effectively prevent excessive deformation of the electrode stack structure 100 through suppressing a phenomenon where deformations with a small radius of curvature, such as wrinkles on other inner layers, tend to occur, and the stress on inner layers may be alleviated.

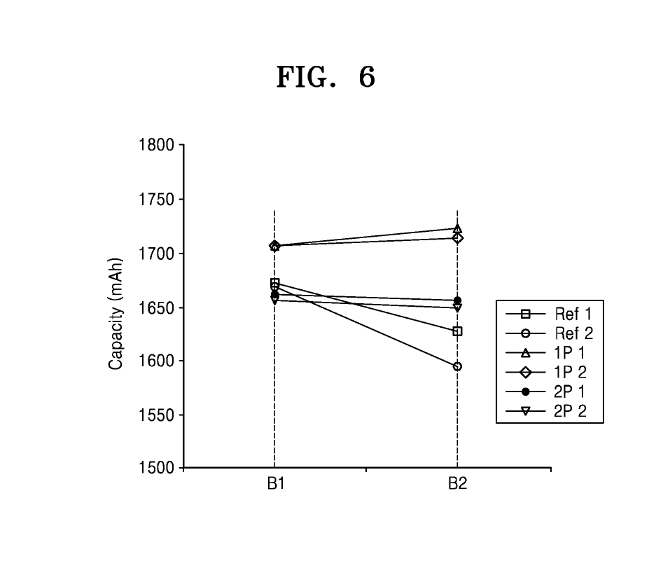

FIG. 6 is a graph showing a capacity comparison before and after bending embodiments of a flexible secondary battery. In FIG. 6, the capacities before and after bending of the flexible secondary batteries are shown. In the graph of FIG. 6, B1 indicates the capacity of flexible secondary batteries before bending, and B2 indicates the capacity when the flexible secondary battery is bowed by bending with a radius of curvature of 50 mm. Ref indicates a flexible secondary battery where a fixing unit is not provided, 1P indicates an embodiment of a flexible secondary battery according to the invention where the fixing unit 200 is provided at the center portion of the electrode stack structure 100 as illustrated in FIG. 3A, and 2P indicates another embodiment of a flexible secondary battery according to the invention including a combined electrode stack structures 100a and 100b as illustrated in FIG. 3B.

Referring to FIG. 6, in an embodiment of the flexible secondary battery where the fixing unit are provided at the center portion of the electrode stack structure, charge capacity 1 P1 and discharge capacity 1 P2 are substantially the same as each other, and in an embodiment of the flexible secondary battery including the combined electrode stack structures 100a an 100b, charge capacity 2P1 and discharge capacity 2P2 are substantially the same as each other. However, in the flexible secondary battery where no fixing unit is provided, charge capacity Ref1 and discharge capacity Ref2 indicate a decrease of about 4%, and a capacity decrease phenomenon significantly occurs. Such capacity decrease may occur by either a space shortage for slipping of inner layers of the electrode stack structure of the flexible secondary battery package, or a space formation between inner electrodes due to friction between inner layers of the electrode stack structure at the time of slipping. As shown in FIG. 6, in an embodiment of a flexible secondary battery 1P and 2P according to the invention, the capacity decrease phenomenon may be effectively prevented from occurring at the time of bending and slipping due to outside pressure, etc., and thus, the flexible secondary battery may have a stabilized electrode stack structure.

According to embodiments of the invention, the capacity decrease phenomenon of the flexible secondary battery may be effectively prevented from occurring at the time of bending or slipping of individual layers that define the electrode stack structure due to outside pressure, etc.

According to embodiments of the invention, at the time of bending or slipping of individual layers that define the electrode stack structure, deformation of inner layers may be substantially reduced, and the alignment of the inner layers may be substantially maintained, and thus, the flexible secondary battery with stable movement characteristics may be realized.

It should be understood that the exemplary embodiments described therein should be considered in a descriptive sense only and not for purposes of limitation. Descriptions of features or aspects within each embodiment should typically be considered as available for other similar features or aspects in other embodiments.

While the invention have been particularly shown and described with reference to exemplary embodiments thereof, it will be understood by those of ordinary skill in the art that various changes in form and details may be made therein without departing from the spirit and scope of the invention as defined by the following claims.

What is claimed is:

1. A flexible secondary battery comprising:
an electrode stack structure comprising:
a first electrode layer;
a second electrode layer disposed opposite to the first electrode layer;
a separator disposed between the first electrode layer and the second electrode layer; and
a fixing unit disposed in the electrode stack structure at an area excluding opposing end portions of the electrode stack structure, wherein the fixing unit fixes portions of the first electrode layer, the second electrode layer and the separator, which correspond thereto, to each other.

2. The flexible secondary battery of claim 1, wherein the fixing unit is disposed at a center portion or an area adjacent to the center portion of the electrode stack structure.

3. The flexible secondary battery of claim 2, wherein the area adjacent to the center portion of the electrode stack structure is closer to the center portion of the electrode stack structure than to one of the opposing end portion of the electrode stack structure.

4. The flexible secondary battery of claim 1, wherein the electrode stack structure further comprises an additional fixing unit.

5. The flexible secondary battery of claim 1, wherein the fixing unit comprises an adhesive or a tape with coated adhesive.

6. The flexible secondary battery of claim 1, wherein the fixing unit is defined by a portion of a spot-welded structure or a riveting structure.

7. The flexible secondary battery of claim 1, wherein
the first electrode layer comprises:
a first metal collector; and
a first active material layer disposed on a surface of the first metal collector, and
the second electrode layer comprises:
a second metal collector; and
a second active material layer disposed on a surface of the second metal collector.

8. The flexible secondary battery of claim 7, further comprising:
a connecting tab defined by a portion of the first metal collector or the second metal collector.

9. The flexible secondary battery of claim 1, further comprising:
a protecting layer disposed on a surface of the electrode stack structure.

10. The flexible secondary battery of claim 9, wherein bending stiffness of the protecting layer is larger than an average bending stiffness of individual layers of the electrode stack structure.

11. The flexible secondary battery of claim 9, wherein
the protecting layer comprises a polymer film, a film comprising a laminated polymer film layer, a metal foil, or a composite film comprising carbon.

12. The flexible secondary battery of claim 1, wherein
the electrode stack structure comprises a first electrode stack structure and a second electrode stack structure, wherein each of the first and second electrode stack structures comprises the first and second electrode layers,
the fixing unit is disposed in the first electrode stack structure and the second electrode stack structure, and
the fixing unit connects the first electrode stack structure and the second electrode stack structure to each other.

13. The flexible secondary battery of claim 12, wherein the first and second electrode layers of the first electrode stack structure and the first and second electrode layers of the second electrode stack structure are connected in series or in parallel to each other.
